(19) United States
(12) Patent Application Publication
(10) Pub. No.: US 2021/0024222 A1
(43) Pub. Date: Jan. 28, 2021

(54) AIRCRAFT SAFETY APPARATUS

(71) Applicant: Jerry Carlisle, Hickory Ridge, AR (US)

(72) Inventor: Jerry Carlisle, Hickory Ridge, AR (US)

(21) Appl. No.: 16/522,859

(22) Filed: Jul. 26, 2019

(51) Int. Cl. B64D 17/80; B64D 17/72; B64D 47/00

(52) U.S. Cl. CPC B64D 17/80; B64D 47/00; B64D 17/725

(57) ABSTRACT

An aircraft safety apparatus removably disposed on at least a portion of an aircraft, the aircraft safety apparatus including a parachute canister, including a main body to store at least one item therein, and at least one parachute disposed within at least a portion of the main body to reduce a rate of descent of the aircraft in response to extraction from the main body, and a rocket canister removably connected to at least a portion of the main body to at least partially fill at least a portion of the main body with a combustible gas, and a gas canister removably connected to at least a portion of the main body to at least partially fill at least a portion of the main body with a non-combustible gas.

### BACKGROUND

### 1. Field

The present general inventive concept relates generally to a safety apparatus, and particularly, to an aircraft safety apparatus.

### 2. Description of the Related Art

Agricultural planes are a type of aircraft usually used to apply pesticides or fertilizer across a large area of land. Unfortunately, flying agricultural planes is a perilous occupation because a mechanical malfunction can cause a plane to come crashing down. Traditional parachute systems are designed to save a life of a pilot. However, the traditional parachute systems do not aide in salvaging the agricultural plane.

Therefore, there is a need for a parachute that will deploy during an emergency event to save the agricultural plane by reducing its rate of descent.

### SUMMARY

The present general inventive concept provides an aircraft safety apparatus.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an aircraft safety apparatus removably disposed on at least a portion of an aircraft, the aircraft safety apparatus including a parachute canister, including a main body to store at least one item therein, and at least one parachute disposed within at least a portion of the main body to reduce a rate of descent of the aircraft in response to extraction from the main body, and a rocket canister removably connected to at least a portion of the main body to at least partially fill at least a portion of the main body with a combustible gas, and a gas canister removably connected to at least a portion of the main body to at least partially fill at least a portion of the main body with a non-combustible gas.

The parachute canister may further include a rocket chamber disposed within at least a portion of the main body to store at least one of the combustible gas and the non-combustible gas.

The parachute canister may further include an ignition chamber disposed within at least a portion of the main body to create a spark to ignite the combustible gas.

The aircraft safety apparatus may further include a firing cable disposed on at least a portion of the main body to activate the ignition chamber in response to moving the firing cable.

The aircraft safety apparatus may further include a plurality of mounting brackets disposed on at least a portion of the aircraft safety apparatus to removably connect the aircraft safety apparatus to at least a portion of the aircraft.

The aircraft safety apparatus may further include a control unit disposed within at least a portion of the main body to extract the at least one parachute in response to a determination of an emergency event.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an isometric view of an aircraft safety apparatus, according to an exemplary embodiment of the present general inventive concept; and

FIG. 2 illustrates a side view of the aircraft safety apparatus as disposed on an aircraft, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Aircraft Safety Apparatus 100
Rocket Canister 110
Connecting Tube 111
Parachute Canister 120
Main Body 121
Lid 122
Parachute 123
Rocket Chamber 124
Ignition Chamber 125
Gas Canister 130
Connecting Tube 131
Mounting Brackets 140
Firing Cable 150
Control Unit 160
Processing Unit 161
Communication Unit 162
Storage Unit 163
Sensor 164

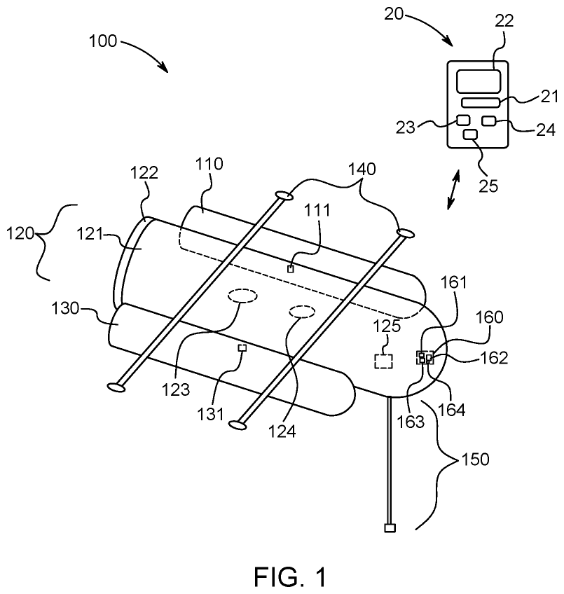

FIG. 1 illustrates an isometric view of an aircraft safety apparatus 100, according to an exemplary embodiment of the present general inventive concept; and

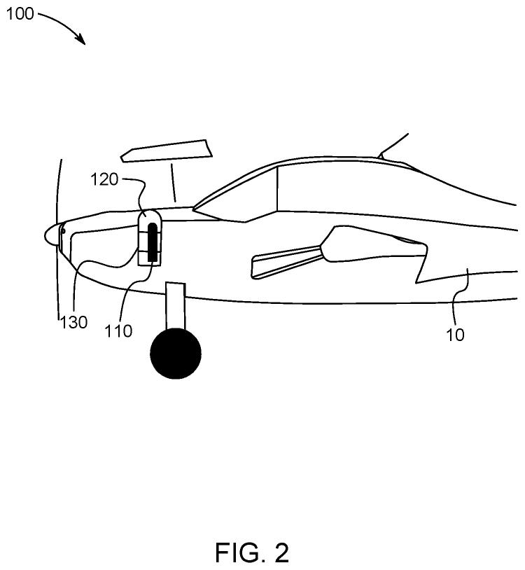

FIG. 2 illustrates a side view of the aircraft safety apparatus 100 as disposed on an aircraft, according to an exemplary embodiment of the present general inventive concept.

The aircraft safety apparatus 100 may be constructed from at least one of metal, plastic, glass, and rubber, etc., but is not limited thereto.

The aircraft safety apparatus 100 may include a rocket canister 110, a parachute canister 120, a gas canister 130, a plurality of mounting brackets 140, a firing cable 150, and a control unit 160, but is not limited thereto.

The rocket canister 110 may include a connecting tube 111, but is not limited thereto.

The rocket canister 110 may store a combustible gas, such as a pyro gas therein, but is not limited thereto.

The parachute canister 120 may include a main body 121, a lid 122, at least one parachute 123, a rocket chamber 124, and an ignition chamber 125, but is not limited thereto.

The main body 121 may be of any predetermined size. The main body 121 may be substantially hollow to store at least one item therein. The lid 122 may be pivotally disposed at an end of the main body 121. As such, the lid 122 may pivot away from the main body 121 in a first direction or a second direction from a first position (i.e. closed) to a second position (i.e. opened), such that a user may access at least a portion of an interior of the main body 121. Alternatively, the lid 122 may pivot at least partially toward the main body 121 in the second direction or the first direction from the second position to the first position, such that the user may not access at least a portion of the interior of the main body 121.

Alternatively, the lid 122 may be removably disposed at the end of the main body 121.

The rocket canister 110 may be removably connected to at least a portion of the main body 121. Specifically, the connecting tube 111 may be inserted into at least a portion of the main body 121, such that the pyro gas may at least partially fill the rocket chamber 124.

The gas canister 130 may include a connecting tube 131, but is not limited thereto.

The gas canister 130 may store a non-combustible gas therein. For example, the gas canister 130 may store CO₂ gas. As such, the gas canister 130 may also be referred to as a CO₂ gas canister 130.

The gas canister 130 may be removably connected to at least a portion of the main body 121. Specifically, the connecting tube 131 may be inserted into at least a portion of the main body 121, such that the non-combustible gas may at least partially fill the rocket chamber 124.

Referring to FIGS. 1 and 2, the plurality of mounting brackets 140 may be removably disposed on at least a portion of at least one of the rocket canister 110, the parachute canister 120, and the gas canister 130. Furthermore, the plurality of mounting brackets 140 may removably connect the aircraft safety apparatus 100 to at least a portion of an aircraft 10, such that the aircraft safety apparatus 100 may be secured thereto.

The firing cable 150 may be disposed on at least a portion of the parachute canister 120. Additionally, the firing cable 150 may be connected to the ignition chamber 125. As such, the ignition chamber 125 may create a spark in response to the user pushing and/or pulling the firing cable 150. Moreover, the pyro gas may ignite in response to the spark from the ignition chamber 125, such that an explosive reaction may extract the at least one parachute 123 out of the main body 121 via the lid 122. The at least one parachute 123 may expand to decrease a rate of descent of the aircraft 10. For example, the at least one parachute 123 may expand to a diameter of one-hundred twenty-five feet.

The non-combustible gas from the gas canister 130 may cool the pyro gas in response to the pyro gas and the non-combustible gas being expelled, such that the at least one parachute 123 may not burn during extraction.

The control unit 160 may include a processing unit 161, a communication unit 162, a storage unit 163, and a sensor 164, but is not limited thereto.

The processing unit 161 (or central processing unit, CPU) may include electronic circuitry to carry out instructions of a computer program by performing basic arithmetic, logical, control and input/output (I/O) operations specified by the instructions. The processing unit 161 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 161 may also include a microprocessor and a microcontroller.

The communication unit 162 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 163 may include a random access memory (RAM), a read-only memory (ROM), a hard disk, a flash drive, a database connected to the Internet, cloud-based storage, Internet-based storage, or any other type of storage unit.

The sensor 164 may include an operating status sensor and an altimeter, but is not limited thereto.

The control unit 160 may be disposed within at least a portion of the main body 121 of the parachute canister 120. The control unit 160 may be preprogrammed and/or customized by the user with at least one predetermined altitude level to fire the parachute 123 from the parachute canister 120. The at least one predetermined altitude level may be stored in the storage unit 163. Additionally, the sensor 164 may detect an altitude level of the aircraft safety apparatus 100 to compare the altitude level with the at least one predetermined altitude level. Moreover, the sensor 164 may detect the operating status of the aircraft 10 to determine whether the aircraft 10 has at least one of a defective engine, a descending trajectory, a fast rate of descent, a defective wing, and a defective yoke, but is not limited thereto. As such, the sensor 164 may transmit an alert signal to the processing unit 161 in response to an emergency event. The emergency event may include the altitude level being at least equivalent to the at least one predetermined altitude level, a fast rate of descent, and/or a defective engine. The processing unit 161 may send a firing signal to the ignition chamber 125, such that the pyro gas in the rocket chamber 124 may ignite to extract the at least one parachute 123. As such, the parachute canister 120 may not activate and/or the lid 122 may not open unless the processing unit 161 sends the firing signal.

Also, the sensor 164 may repeat the above steps to detect another altitude level of the aircraft safety apparatus 100 to compare the another altitude level with another at least one predetermined altitude level, such that the processing unit 161 may send another firing signal to the ignition chamber 125, such that the pyro gas in the rocket chamber 124 may ignite to extract another at least one parachute 123. The another at least one parachute 123 may be used at the another altitude level to further reduce the fast rate of descent.

The computing device 20 may be a mobile phone, a laptop computer, a tablet computer, a desktop computer, a palm pilot, a smart watch, etc., but is not limited thereto, and may be any type of mobile device that connects to the Internet or any other type of network. In other words, the computing device 20 may also be referenced as an apparatus 20, for at least the reason that the mobile device 20 may be movable or stationary, depending on the user's preferences.

The computing device 20 may include an input unit 21, display unit 22, a processing unit 23, a communication unit 24, and a storage unit 25.

The input unit 21 may include a keyboard, a touchpad, a mouse, a trackball, a stylus, a voice recognition unit, a visual data reader, a camera, a wireless device reader, and a holographic input unit.

The display unit 22 may include a plasma screen, an LCD screen, a light emitting diode (LED) screen, an organic LED (OLED) screen, a computer monitor, a hologram output unit, a sound outputting unit, or any other type of device that visually or aurally displays data.

Also, the display unit 22 may be combined with the input unit 21 to be a touch-screen.

The processing unit 23 (or central processing unit, CPU) may include electronic circuitry to carry out instructions of a computer program by performing basic arithmetic, logical, control and input/output (I/O) operations specified by the instructions. The processing unit 23 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 23 may also include a microprocessor and a microcontroller.

The communication unit 24 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 25 may include a random access memory (RAM), a read-only memory (ROM), a hard disk, a flash drive, a database connected to the Internet, cloud-based storage, Internet-based storage, or any other type of storage unit.

The computing device 20 may access the Internet via the communication unit 24 to allow the user to access a website, and/or may allow a program and/or an application to be executed using the processing unit 23. For ease of description, the program and/or the application will hereinafter be referred to as an app. The app may be downloaded from the Internet to be stored on the storage unit 25. Moreover, the app may be designed to control the control unit 160 of the aircraft safety apparatus 100.

After executing the app, the user may perform any of the functions of the control unit 160 as described above. Additionally, the user may view the display unit 22 to view the altitude level of the aircraft safety apparatus 100. As such, the user may enter an input on the input unit 21 to send a command to the processing unit 23. The processing unit 23 may send a signal to the communication unit 24, such that the communication unit 24 may send the signal to the communication unit 163 of the control unit 160 to perform any of the functions of the control unit 160 as described above.

Also, the user may retrieve a preprogrammed configuration from the storage unit 25 to adjust settings on the control unit 160 using the app.

Therefore, the aircraft safety apparatus 100 may save the aircraft 10 during the emergency event by preventing a crash that can damage and/or destroy the aircraft 10 entirely. As such, the aircraft safety apparatus 100 may reduce insurance costs of the user.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An aircraft safety apparatus removably disposed on at least a portion of an aircraft, the aircraft safety apparatus comprising:
a parachute canister, comprising:
a main body to store at least one item therein, and
at least one parachute disposed within at least a portion of the main body to reduce a rate of descent of the aircraft in response to extraction from the main body;
a rocket canister removably connected to at least a portion of the main body to at least partially fill at least a portion of the main body with a combustible gas; and
a gas canister removably connected to at least a portion of the main body to at least partially fill at least a portion of the main body with a non-combustible gas.

2. The aircraft safety apparatus of claim 1, wherein the parachute canister further comprises:
a rocket chamber disposed within at least a portion of the main body to store at least one of the combustible gas and the non-combustible gas.

3. The aircraft safety apparatus of claim 1, wherein the parachute canister further comprises:
an ignition chamber disposed within at least a portion of the main body to create a spark to ignite the combustible gas.

4. The aircraft safety apparatus of claim 3, further comprising:
a firing cable disposed on at least a portion of the main body to activate the ignition chamber in response to moving the firing cable.

5. The aircraft safety apparatus of claim 1, further comprising:
a plurality of mounting brackets disposed on at least a portion of the aircraft safety apparatus to removably connect the aircraft safety apparatus to at least a portion of the aircraft.

6. The aircraft safety apparatus of claim 1, further comprising:
a control unit disposed within at least a portion of the main body to extract the at least one parachute in response to a determination of an emergency event.
